(19) United States
(12) Patent Application Publication
(10) Pub. No.: US 2011/0163523 A1
(43) Pub. Date: Jul. 7, 2011

(54) TRAILER SUPPORT APPARATUS AND METHODS

(76) Inventor: Ken Smith, Woodburn, OR (US)

(21) Appl. No.: 12/984,525

(22) Filed: Jan. 4, 2011

Related U.S. Application Data
(60) Provisional application No. 61/292,012, filed on Jan. 4, 2010.

(51) Int. Cl. B60S 9/02

(52) U.S. Cl. 280/763.1

(57) ABSTRACT

Adjustable trailer supports and method for propping up a trailer with adjustable trailer supports, the adjustable trailer supports including a body element configured to couple to the front end of the trailer, a leg for supporting the trailer, the leg including a pivot element having a proximal end pivotably coupled to the body element and a distal end, and an extension element slidably coupled to the distal end of the pivot element, wherein the leg is configured to pivot between a stowed position and a support position. In some examples, the leg includes a pivot element and does not include an extension element.

This application claims the benefit of U.S. application, Ser. No. 61292012, filed on Jan. 4, 2010, which is hereby incorporated by reference for all purposes.

### BACKGROUND

The present disclosure relates generally to trailer supports. In particular, trailer supports configured to pivot from a stowed position to a support position to drain water from a boat supported by a trailer are described herein.

Known trailer supports are not entirely satisfactory for the range of applications in which they are employed. Specifically, known trailer supports are not satisfactory for draining water from a boat stored on a trailer. If a boat is stored on a trailer, one option for draining water from the boat is to support the trailer at an angle so that the drain hole of the boat is at or near the boat's lowest point, For example, the tongue of the trailer may be supported an elevated position by a stack of tires, an elongated piece of wood (such as a two-by-four beam), or any other miscellaneous object to which a boat user has access. These support devices, though providing any desired elevation of the trailer, often suffer from severe safety and strength problems.

As another example, the trailer may be supported by integral trailer stand attached to the tongue of the trailer. These support devices often suffer from lack of adjust-ability and difficulty in storage due to their design. In addition, many of these devices add excessive weight to the tongue of the trailer, and may be difficult to deploy and/or adjust by a single person.

Thus, there exists a need for trailer supports that improve upon and advances the design of known trailer supports. Examples of new and useful trailer supports relevant to the needs existing in the field are discussed below.

Disclosure addressing one or more of the identified existing needs is provided in the detailed description below. References relevant to trailer supports include U.S. patent References: USD269420, USD291017, USD310799, U.S. Pat. No. 3,345,037, U.S. Pat. No. 4,372,569, U.S. Pat. No. 4,469,348, U.S. Pat. No. 4,548,418, and U.S. Pat. No. 5,040,937. The complete disclosures of the above patents and patent applications are herein incorporated by reference for all purposes.

### SUMMARY

The present disclosure is directed to trailer supports and methods to support and elevate a trailer at various heights to facilitate water drainage from a boat supported on the trailer. In one embodiment, the present trailer support includes a coupling plate coupled configured to couple to a tongue section of a trailer, a pivot plate attached to the coupling plate, the pivot plate including a pivot hole and defining a plurality of pivot plate lock holes, a pivot element including a proximal end and a distal end opposite the proximal end and defining a plurality of pivot element lock holes, and the proximal end of the pivot element being pivotally fixed at the pivot hole and moveable along an arc from a stowed position extending substantially parallel to the tongue section to a substantially upright support position, wherein at least one of the plurality of pivot element lock holes may be selectively aligned with at least one of the plurality of pivot plate lock holes for locking the pivot element.

### BRIEF DESCRIPTION OF THE DRAWINGS

FIG. 1 is an isometric view of a first example of trailer support, the trailer sup port a support position to support a boat trailer and boat at an incline relative to the ground.

FIG. 2 is an isometric view of the trailer support of FIG. 1 in a stowed position for transport.

FIG. 3 is a front view of the trailer support of FIG. 1 in the support position and with a foot comprising a plate.

FIG. 4 is a top view of the trailer support of FIG. 1 in the stowed position and with a foot comprising a wheel.

FIG. 5 is a side elevation view of a portion of the trailer support of FIG. 1.

FIG. 6 is isometric view from below of a portion of the trailer support of FIG. 1 in use with a trailer supporting a boat.

FIG. 7 is a side elevation view of a second example of a trailer support with a foot comprising a wheel.

FIG. 8 is a side elevation view of the trailer support of FIG. 7 with the foot comprising a plate.

FIG. 9 is a side view of the trailer support of FIG. 7 depicting the trailer support receiving a plate and a wheel as an interchangeable foot.

FIG. 10 is a flowchart of a method for draining water from a boat supported on a trailer.

### DETAILED DESCRIPTION

The disclosed trailer supports will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various trailer supports are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

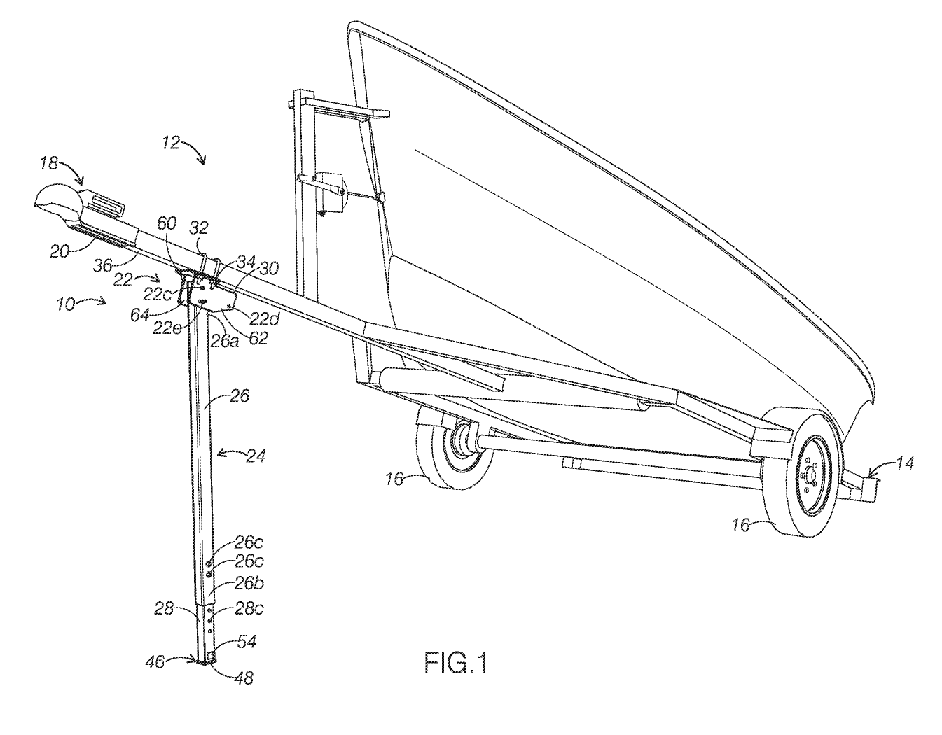

With reference to FIG. 1, an adjustable trailer support 10 for propping up a trailer 12 will be described. Trailer 12 has a rear end 14 supported by wheels 16 and a front end 18 including a tongue 20. Trailer support 10 includes a body element 22, leg 24, a pivot element 26, and an extension element 28.

The illustrated embodiment of an adjustable trailer support is made of a metallic material, typically steel or aluminum, which can be welded, machined, cast, and otherwise formed as necessary. However, other materials may be used in constructing a trailer support, provided the appropriate modifications are made to the way the pieces are coupled to one another and to a supported object. For example, the support could be made of composite materials (such as carbon fiber), or plastics, or a combination of appropriate materials.

Body element 22 is configured to couple to front end 18 of trailer 12. Body element includes a coupling plate 60, a first pivot member 62, and a second pivot member 64. Body element 22 is made of a metallic material, such as aluminum or steel, which can be cast, welded, machined, and otherwise formed as necessary.

In the example shown in FIGS. 1-6, body element 22 defines an integral member, with coupling plate 60, first pivot member 62 and second pivot member 64 being integrally formed with one another. Metal casting is one suitable method for forming an integral body member. In other examples, body element is formed by assembling distinct components together, with the first and second pivot members being fastened to the coupling plate by a suitable means, such as welding.

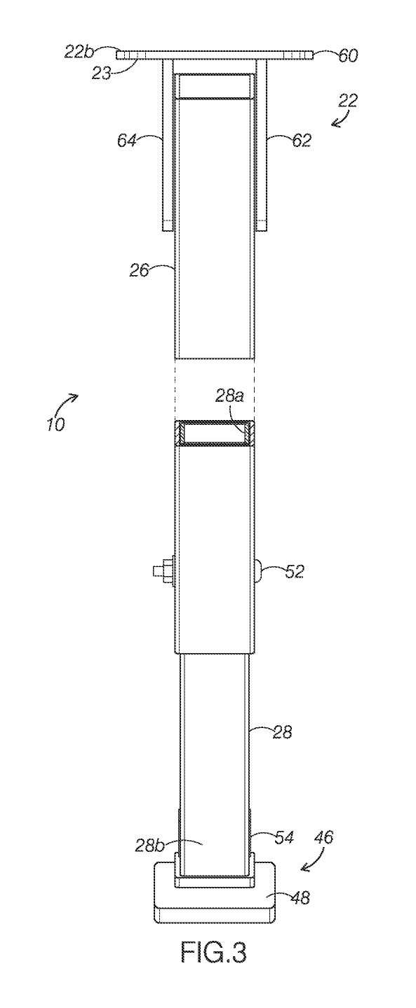

As shown in FIG. 3, coupling plate 60 is substantially planer with a first face or upper surface 22b oriented toward a trailer in normal operation and a second face or bottom surface 23 opposite upper surface 22b. First pivot member 62 projects from second face 23, and second pivot member 64 projects from second face 23 from a position spaced from first pivot member 62. In the particular example shown in FIGS. 1-6, first pivot member 62 and second pivot member 64 are substantially identical planar members and are aligned substantially parallel to one another. However, in some examples the pivot members are not identical and are not aligned in parallel. Further, in some examples the body element includes just a single pivot member.

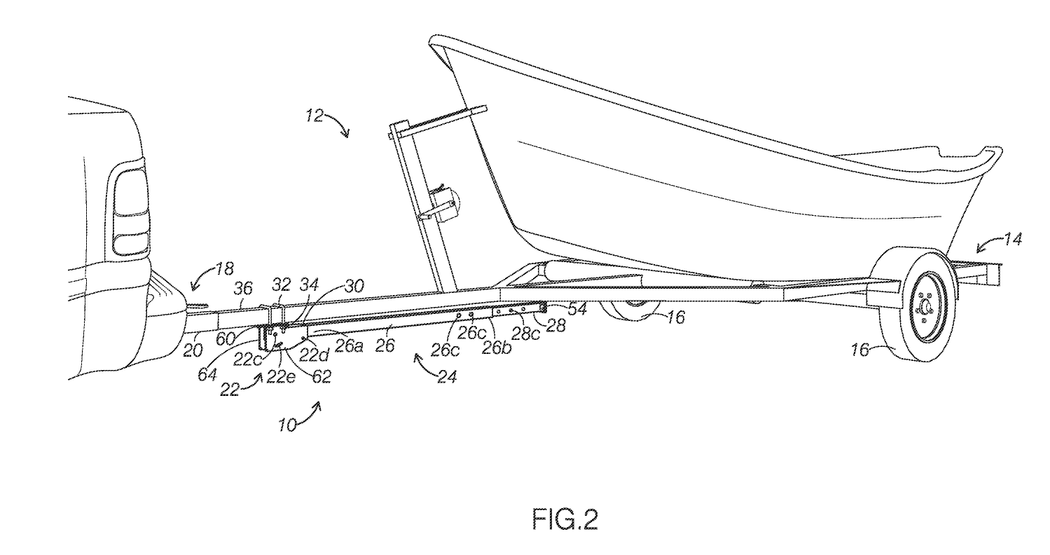

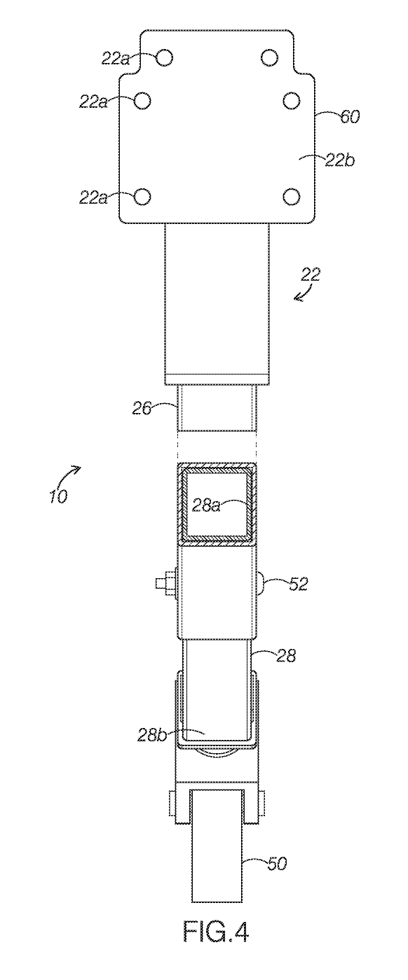

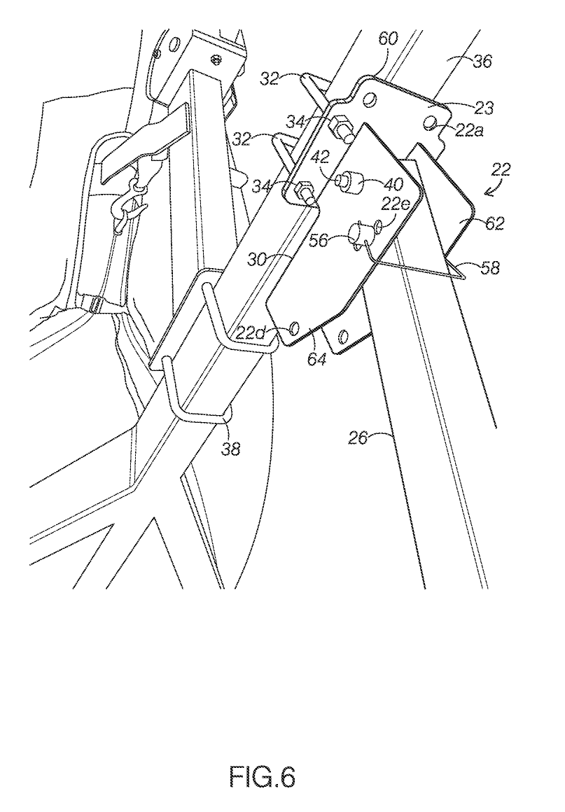

Coupling plate 60 defines a number of coupling holes 22a, as shown perhaps most clearly FIG. 4. The coupling holes 22a are used to fasten coupling plate 60 to a portion of a trailer through the use of (for example) one or more U-bolts 32 with associated nuts 34 (as shown in FIGS. 1 and 2 and in more detail in FIG. 6). Coupling holes 22a may have any desired spatial arrangement to accommodate different configurations of trailers, coupling plates, mounting means, and so on.

In the illustrated embodiment, for example, coupling holes 22a having spacing appropriate for a 2-inch trailer beam are shown toward the top of FIG. 4. Other pairs of coupling holes with spacing appropriate to accommodate a 3-inch trailer beam are shown towards the middle and bottom of coupling plate 60 as oriented in FIG. 4. Many other arrangements are possible.

In FIG. 4, upper surface 22h of coupling plate 60, which will reside closest to a trailer frame beam, is shown as being bare. However, it is possible to provide accessory material for upper surface 22b of coupling plate 60 to protect and/or enhance the friction at the interface between the plate and a beam. For example, the coupling plate could be provided with a removable or integral gasket constructed of rubber or another resilient material. As another example, the coupling plate could be coated with a textured material to provide grip against the beam.

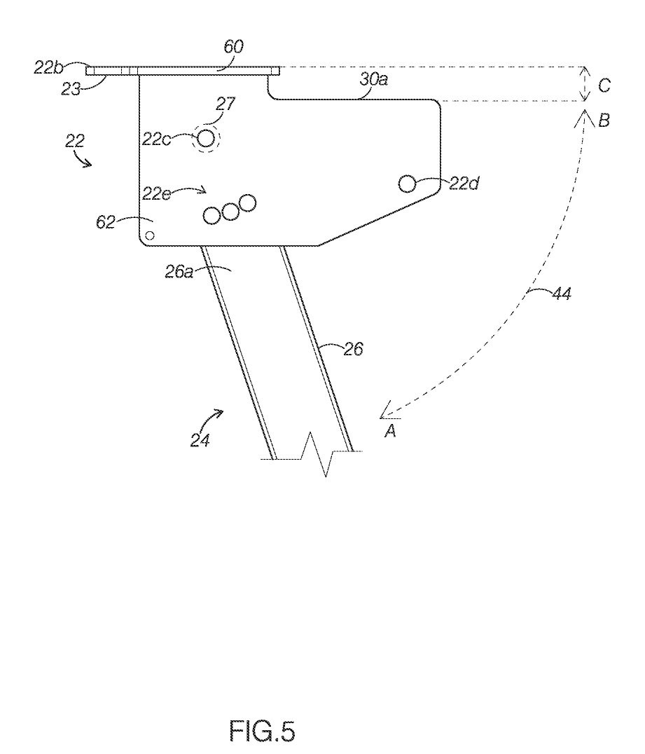

As shown most clearly in FIGS. 5 and 6, first pivot member 62 (and in identical fashion, though not shown, second pivot member 64) defines a step 30 to accommodate various portions of the trailer to which body element 22 is coupled. Step 30 of the illustrated embodiment is a relief defined in first pivot member 62 that provides for spatial separation (denoted by distance C) between top surface 22b of body element 22 and a top surface 30a of step 30.

Thus, as shown in FIG. 6, when body element 22 is placed against a beam of a trailer, the steps provide open space near the trailer beam to accommodate (for example) U-bolts 32 or other features that may otherwise interfere with placement of adjustable trailer support 10. Steps 30 may be formed in the pivot plates by machining, laser cutting, water-jet cutting, casting, or any other appropriate technique.

FIG. 6 shows the first embodiment of a trailer support, in use with a boat and trailer. Adjustable trailer support 10 may be fixed to the trailer permanently or removably. In the illustrated embodiment, adjustable trailer support 10 is removably fixed, via one or more U-bolts 32 and nuts 34, to a portion of a trailer frame beam 36 of a boat trailer. As seen in the Figures, steps 30 provide space between adjustable trailer support 10 and trailer frame beam 36, such that the support could be moved further toward the rear of the boat trailer without interfering with trailer bolts 38.

As shown in FIG. 1, leg 24 for supporting the trailer includes pivot element 26 having a proximal end 26a and a di end 26b opposite proximal end 26a. Proximal end 26a of pivot element 26 is pivotably coupled to first and second pivot members 62 and 64. Body element 22 includes a number of features to pivotably couple or rotatably support leg 24 and reversibly fix its position.

As shown in FIG. 5, the illustrated first pivot member 62 includes a body lock hole 22c. Pivot element 26 includes one or more pivot element lock holes 27 located between proximal end 26a of pivot element 26 and distal end 26b of pivot element 26.

To lock pivot element 26 to body element 22 in a pivotable manner, a user of adjustable trailer support 10 may align a body lock hole 22c with a pivot element lock hole 27. The user may then pass a bolt, pin, or other fixation element, such as a nylon nut 40 (or Nylok nut) and bolt 42 as shown in FIG. 6, through the aligned holes to fix the pivot element in a way that maintains its rotational position relative to body element 22. The fixation element may be put into place permanently or temporarily, though the illustrated embodiment contemplates removable fixation in most cases.

Once fixed at pivot element lock hole 27 by pivot element 26, leg 24 may be relatively freely moved along arc 44 as shown most clearly in FIG. 5. At one point along arc 44, corresponding to the relatively vertical orientation of leg 24 shown in FIG. 1 (position), leg 24 may be used to support the trailer to which it is attached. At another point along arc corresponding to a relatively horizontal orientation of leg 24 shown in FIG. 2 (position B), leg 24 may be stowed when it is not in use supporting a trailer.

To accomplish vertical and horizontal positioning, the pivot element lock holes and body lock holes may be used. First pivot member 62 defines a stowed lock hole 22d for holding leg 24 in a stowed position, which is relatively horizontal in this example. To hold the leg in this position, it may first be rotated around its fixation point at one of the pivot element lock holes. When leg 24 reaches a substantially horizontal position (position B), a bolt, pin or other fixation element may be passed through stowed lock hole 22d, which is aligned with a corresponding stowed lock hole defined in the second pivot member. In the present example, the stowed lock holes are positioned such that leg 24 can be supported on top of the bolt, or other fixation element when inserted through the stowed lock holes. In other examples, a complimentary hole is defined in the leg and aligned with the stowed lock holes such that placing a bolt through the aligned holes supports the leg.

Likewise, body element 22 includes deployed lock holes 22e for holding leg 24 in a deployed position, which is relatively vertical in the example shown in FIGS. 1-6. Though not shown in the figures, pivot element 26 defines a deployed receiving hole for receiving a bolt to hold pivot element 26 in a fixed position relative to body element 22. To hold leg 24 in the deployed position, leg 24 is first rotated around its fixation point at one of the pivot element lock holes. Deployed lock holes 22e are positioned such that deployed receiving holes defined in pivot element 26 align with deployed lock holes 22e when leg 24 reaches a substantially vertical position (position A). When aligned, a pin 56 or other fixation element may be passed through deployed lock holes 22e aligned with the deployed receiving holes in pivot element 26 to hold leg 24 in the deployed position. As shown in FIG. 6, pin 56 may be held in position by a removable security cable 58.

As shown in the figures, leg 24 further includes extension element 28, which is slidably coupled to distal end 26b of pivot element 26. Leg 24 is configured to pivot between a stowed position B where the leg is longitudinally aligned with the trailer as shown in FIG. 2 and a support position A where the leg is substantially upright as shown in FIG. 1.

To extend and retract leg 24, pivot element 26 defines a plurality of pivot element lock holes 26c between proximal end 26a of pivot element 26 and distal end 26b of pivot element 26. Additionally, extension element 28 includes a proximal end 28a and a distal end 28b opposite proximal end 28a and defines a plurality of extension element lock holes 28c. Pivot element lock holes 26c may be used in concert with one or more extension element lock holes 28c provided in extension element 28.

To lock pivot element 26 and extension element 28 in a desired lengthwise configuration, a user of the adjustable trailer support 10 may a pivot element lock hole 26c with a desired extension element lock hole 28c. A user may then pass a bolt 52 (as shown in FIGS. 3 and 4), pin, or other fixation element (not shown) through the aligned holes to fix their relative position.

The fixation element may be put to place permanently or temporarily, though the illustrated embodiment contemplates removable fixation in most cases. Using the described mechanism, the disclosed adjustable trailer support 10 may be fixed to different lengths. In the example shown the figures, the adjustable length spans between 36 to 62 inches. Embodiments accommodating shorter or longer overall lengths may, of course, be constructed.

Additionally, adjustable trailer support 10 may be adjusted to change the elevation of the front end of the trailer relative to the rear end of the trailer. For example, adjusting extension element 28 from a first position of an initial length, for example inches, to a second position of a second length for example 62 inches, may cause the trailer to adjust from a first angle to a second angle whereby the front end of the trailer is elevated relative to the rear end of the trailer.

The first angle and the second angle may be measured between a trailer plane and a surface contact plane. The trailer plane being defined as substantially longitudinal with the tongue of the trailer and intersecting the front end of the trailer and the rear end of the trailer. The surface contact plane being defined as intersecting a point of contact of the extension element and points of contact of the trailer wheels.

Extension element 28 is internally spring-loaded against pivot element 26 to assist with extending and retracting extension element 28, Expressed another way, a spring (not pictured) resides inside pivot element 28, between an upper end of extension element 28 and an internal upper portion of pivot element 26. Such spring loading assists when either extending or retracting extension element 28 relative to pivot element 26.

Alternatively, the extension element and the pivot element may move past each other without assistance from a spring or other biasing means. For example, a user may simply slide the two elements past each other by hand, or an extension element may slide out of the pivot element when the pivot element is rotated to a relatively vertical position.

Further, the pivot and extension elements may be provided with structures to prevent them from sliding past each other so far that they are no longer coupled. For example, the two elements may contain raised or indented portions of their side walls that collide when the extension element reaches a selected maximum travel distance, thus inhibiting or preventing it from falling out of the pivot element. Although shown as having the extension element reside partially within the pivot element, this arrangement may be reversed without affecting the function of the trailer support.

As can be seen from the Figures, body element 22 may be a cast part, for example aluminum or steel, with cast or machined holes. Alternatively, the body element may be constructed out of a plate material, for example plate steel. Leg 24 may be constructed of tubular material, for example tubular steel. Typically the tubular material has a substantially square cross-section.

However, tubes having other shapes may be used, as appropriate. For example, the leg could be made of tubular steel having an oval cross-section, or it could be of a non-tubular I-beam design. Many different configurations are possible which will provide the same or similar functions and capabilities.

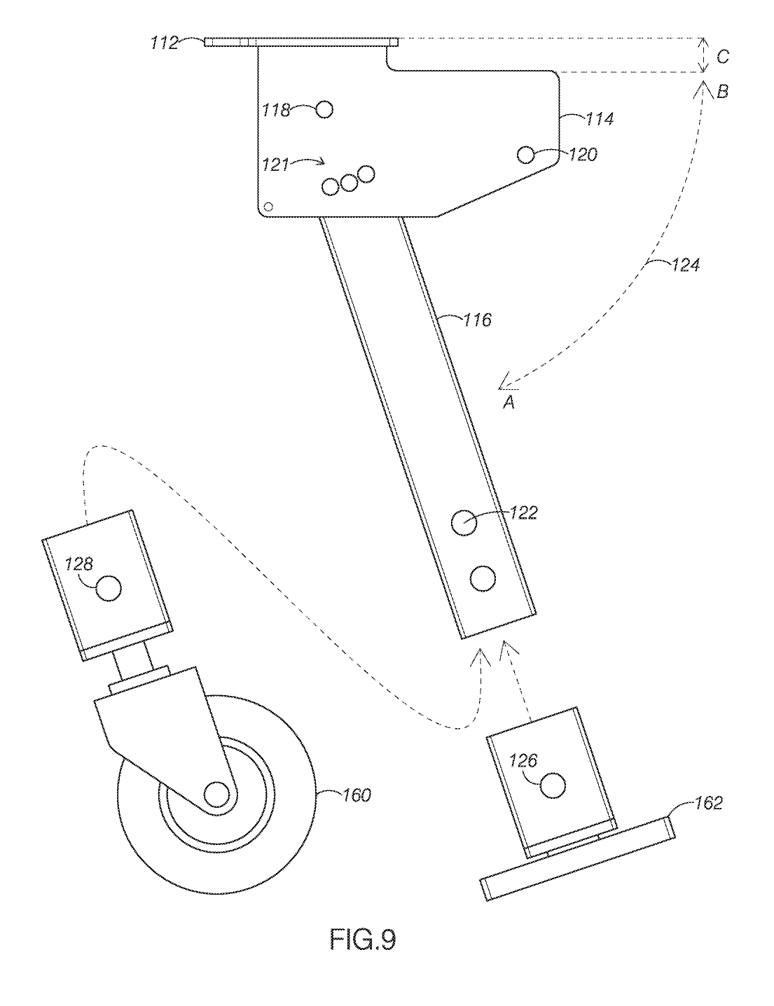

As seen in FIGS. 1-4, extension element 28 includes a foot 46 at distal end 28b. Foot 46 may be used as the primary contact point with a surface upon which adjustable trailer support 10 comes in contact. As such, foot 46 may be a static plate 48 (as shown in FIGS. 1-3) or it may be a rotatable wheel 50 (as show in FIG. 4), or it may be any other appropriate element. Also, in some embodiments the static plate, wheel, or other device may be removable and/or interchangeable (similar to the embodiment shown in FIG. 9), such that any desired foot may be placed on extension element 28 depending on the circumstances.

The particular configuration of the foot, whether it be a plate, wheel, or other structure may provide advantages for certain applications. For example, providing a static plate may make the support more stable, such as on angled ground. Providing a wheel may make the trailer support more maneuverable.

In the example shown in FIGS. 1-6, leg 24 includes features to reduce or prevent water and debris from accumulating internally. For example, foot 46 may include a drain hole in its bottom portion (not shown). Such a hole may prevent the trailer support from accumulating water or other debris during use. As shown in FIG. 1-3, extension element 28 defines a gap 54 proximate foot 46 out of which water may drain and debris may be removed.

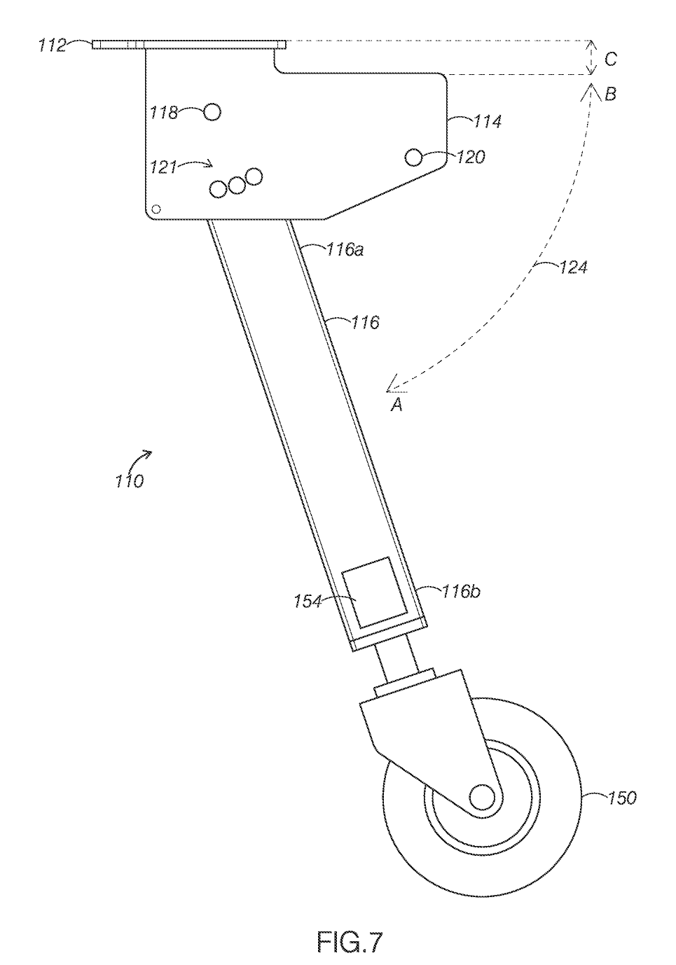

Turning attention to FIGS. 7-9, a second example of a trailer support, trailer support 110, will now be described. Trailer support 110 includes many similar or identical features to trailer support 10 combined in unique and distinct ways. Thus, for the sake of brevity, each feature of trailer support 110 will not be redundantly explained. Rather, key distinctions between trailer support 110 and trailer support 10 swill be described in detail and the reader should reference the discussion above for features substantially similar between the two trailer supports.

As can be seen in FIG. 7, trailer support 110 includes a coupling plate 112, a pivot plate 114, and a pivot element 116. Trailer support 110 is configured for supporting a trailer having a tongue section located at a front end of a trailer and a rear end having wheels. A key distinction between trailer support 10 described above and trailer support 110 is that trailer support 110 does not include an extension element.

Instead, trailer support 110 includes a unitary pivot element 116 that adjusts the height of the front of the trailer relative to the height of the rear of the trailer by deploying between a stowed position and a deployed position. In this manner, the length of pivot element 116 determines directly the height to which the front of the trailer will be elevated and supported. A unitary pivot element, such as pivot element 116, may be preferred in some applications to simplify manufacturing, reduce design complexity, and reduce the number of moving parts of the trailer support. However, the combination of a pivot element and an extension element, such as pivot element 26 and extension element 28, may be preferred in other applications to provide a trailer support with more flexibility and range of use.

Coupling plate 112 is configured to couple to the to section of the trailer. Pivot plate 114 is attached to the coupling plate and defines a pivot hole 118 and defines a plurality of pivot plate lock holes 120.

Typically, and in the illustrated embodiment, coupling plate 112 send pivot plates 114 will be made of a metal, such as steel. To help fix the relative arrangement of coupling plate 112 and pivot plates 114, they may be welded together. In addition, coupling plate 112 may include a plate slot, and each pivot plate 114 may include a complementary plate tab. The plate tab can be inserted into the slot, helping to stabilize the final welded assembly.

The final welded assembly of the coupling plate and one or more pivot dates is similar in function and shares many of the same features as body element 22 discussed above. Because of the similarities between the final welded assembly and body element 22 the reader is advised to refer to the discussion above for in depth detail relating to the coupling plate and pivot plate features alone or in combination.

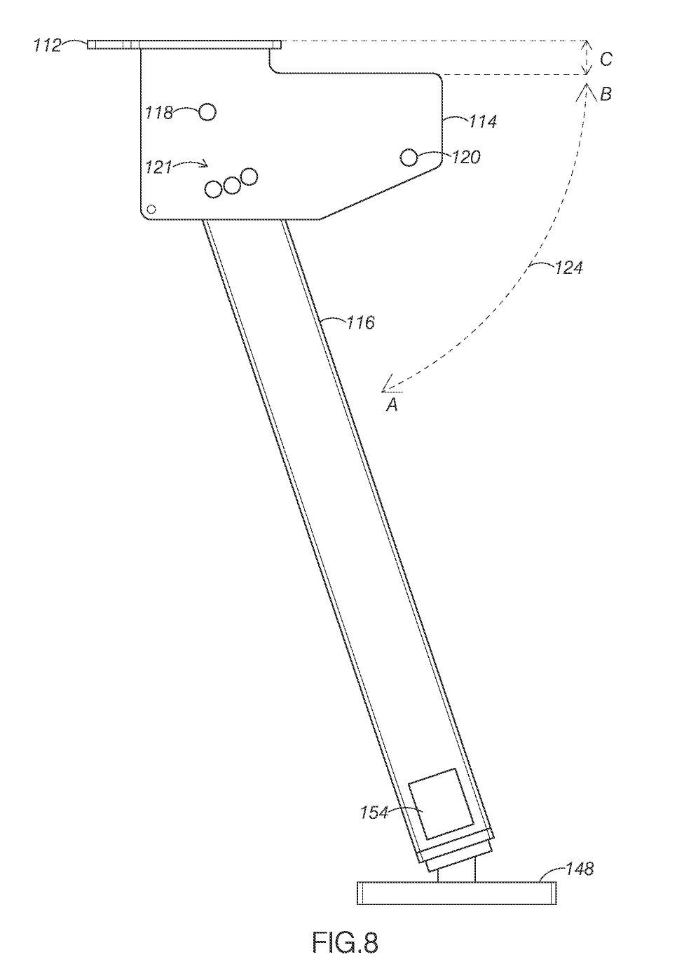

Pivot element 116 includes a proximal end 116a and a distal end 116b opposite the proximal end 116a and defines a plurality of pivot element lock holes. Proximal end 116a of pivot element 116 is pivotally fixed at pivot hole 118 of pivot plate 114. As shown in FIG. 8, pivot element 116 is moveable along an arc 124 from a stowed position (position B) extending substantially parallel to the tongue section to a substantially upright support position (position A). One or more pivot element lock holes may be selectively aligned with at least one of the plurality of pivot plate lock holes for locking pivot element.

The illustrated embodiment includes a pair of pivot plates 114 welded to a single coupling plate 112, but other arrangements are possible while maintaining the function of those elements. For example, some embodiments may function with only a single pivot plate, or with a coupling plate having a different shape.

Coupling plate 112 may include a number of coupling holes similar to those on the body element described above and shown on the body element more clearly in FIG. 4. The coupling holes may be used to allow the coupling plate to be fastened to a portion of a trailer through the use of (for example) one or more U-bolts with associated nuts. Coupling holes may have any desired spatial arrangement to accommodate different configurations of trailers, coupling plates, mounting means, and so on.

Coupling plate 112 further includes an upper surface, which is similar to the upper surface of the body element described above and shown in FIG. 4. The upper surface will reside closest to a trailer frame beam and may be bare or, in some embodiments, there may be an accessory material to protect and/or enhance the friction at the interface between the coupling plate and the trailer frame beam. For example, the coupling plate could be provided with a removable or integral gasket constructed of rubber or another resilient material. As another example, the coupling plate could be coated with a textured material to provide grip against the beam.

Each pivot plate 114 includes features to rotatably support picot 116 and reversibly fix its position. As shown in FIG. 7, the illustrated pivot plates 114 include a pivot hole 118 to which pivot element 116 may be pivotably coupled by a proximal hole similar to the process described above. The fixation element may be put in place permanently or temporarily, though the illustrated embodiment contemplates removable fixation in most cases.

Once fixed at the pivot hole, pivot element 116 may be relatively freely moved along arc 124 as shown FIG. 7. At one point along arc 124, corresponding to the relatively vertical orientation (in the direction of A in FIG. 7), pivot element 116 be used to support the trailer to which it is attached. At another point along arc 124, corresponding to a relatively horizontal orientation in the direction of B in FIG. 7), pivot element 116 may be stowed when it is not in use supporting a trailer.

To fix pivot element desired rotational position, the pivot plates define a plurality of lock holes 120. The pivot plates define a horizontal lock hole 120 for holding pivot element 116 in a relatively horizontal position. To hold pivot element 116 in this position, it may first be rotated around its fixation point at the pivot hole. When pivot element 116 reaches a substantially horizontal position (position B), a bolt, pin or other fixation element may be passel through aligned horizontal lock holes 120 in the pivot plates.

In the illustrated embodiment, the horizontal lock holes 120 are placed such that pivot element 116 can be supported above the bolt, pin, or other fixation element. The fixation element may or may not pass through the leg to fix the posit of pivot element 116.

Likewise, pivot plates 114 include deployed lock holes 121 for holding pivot element in a deployed or support position, which is relatively vertical in the example shown in FIGS. 7-9. Though not shown in the figures, pivot element 116 defines a deployed receiving hole for receiving a bolt to hold pivot element 116 in a fixed position relative to pivot plates 114. To hold pivot element 116 in the deployed position, pivot element 116 is first rotated around its fixation point at one of the pivot element lock holes. Deployed lock holes 121 are positioned such that deployed receiving holes defined in pivot element 116 align with deployed lock holes 121 when pivot element 116 reaches a substantially vertical position (position A). When aligned, a pin or other fixation element may be passed through deployed lock holes 121 aligned with the deployed receiving holes in pivot element 116 to hold pivot element 116 in the deployed or support position. Pivot element 116, may be held in position using a pin and a removable security cable similar to the process described above with regard to adjustable trailer support 10.

Pivot plate 114 may additionally define an integrated step C to accommodate components of the tongue section of the trailer. Integrated step C is similar many respects to the integrated discussed above with respect to the first embodiment.

In some embodiments, trailer support 110 may include an extension element which is similar to the extension element described above with regard to the first embodiment. The extension element may include a proximal end and a distal end opposite proximal end, and the extension element may define a plurality of extension element lock holes. The proximal end of extension element may be slidably coupled to distal end 116b of pivot element 116. Additionally, at least one of the plurality of pivot element lock holes may be selectively aligned with at least one of the plurality of extension element lock holes for locking extension element. For further detail the reader should refer to the discussion above on the extension element.

In some embodiments, the extension element may be configured to extend and change the elevation of the tongue section of the trailer relative to the rear end of the trailer. Additionally, extension element may reside partially within the pivot element. In other embodiments, the pivot element may reside partially within the extension element.

As seen in FIGS. 7-9, pivot element 116 includes a foot element at distal end 116b similar to the foot elements described above. The foot element may be used as the primary contact point pith a surface upon which trailer support 110 comes in contact. As such, the foot may be a rotatable wheel 150 (as shown FIG. 7) or it may be a static plate 148 (as shown in FIG. 8), or it may be any other appropriate element. Also, some embodiments may include a removable and/or interchangeable rotatable wheel 160 and/or interchangeable static plate 162 (as shown in FIG. 9), or other device may be removable and/or interchangeable, such that any desired foot may be placed on pivot element 116 depend the circumstances.

To lock interchangeable rotatable wheel 160 and pivot element 116 in a desired configuration, a user of trailer support 110 may align a rotatable wheel lock hole 128 with a desired pivot element lock hole 122. A user may then pass a bolt, pin, or other fixation element (not shown) through the aligned holes to fix their relative position. Similarly, to lock interchangeable static plate 162 and pivot element 116 in a desired configuration, a user of trailer support 110 may align a static plate lock hole 126 with a desired pivot element lock hole 122. A user may then pass a bolt, pin, or other fixation element (not shown) through the aligned holes to fix their relative position.

The fixation element may be put into place permanently or temporarily though the illustrated embodiment contemplates removable fixation in most cases. To release interchangeable rotatable wheel 160 from pivot element 116 a user may simply remove the fixation element that aligns rotatable wheel lock hole 128 with pivot element lock hole 122. Interchangeable static plate 162 may be removed from pivot element 116 in a similar mariner.

The particular configuration of the foot, whether it be a static plate, rotatable wheel, or other structure may provide advantages for certain applications. For example, providing a static plate may make the support lore stable, such as on angled ground. Providing a wheel may make the trailer support more maneuverable. Additionally, having an interchangeable foot allows users to have greater flexibility and to switch between a static plate, rotatable wheel, or other device to flu their needs and circumstances.

A pivot element without an interchangeable static plate (as shown in FIG. 8) or interchangeable rotatable wheel (as shown in FIG. 7), may be preferred in some applications to simplify manufacturing, reduce design complexity, and reduce the number of moving parts of the trailer support. However, an interchangeable static plate, interchangeable rotatable wheel, or other device (as shown in FIG. 9), may be preferred in other applications to provide a trailer support with more flexibility and range of use.

In the example shown in FIGS. 8-9, pivot element 116 includes features to reduce or prevent water and debris from accumulating internally. For example, static plate 148 and/or interchangeable static plate 162 may include a drain hole in its bottom portion (not shown). Such a hole may prevent the trailer support from accumulating water or other debris during use. As shown in FIG. 7, pivot element 116 defines a gap 154 proximate rotatable wheel 150 out of which water may drain and debris may be removed. Likewise, in FIG. 8, pivot element 116 defines a gap 154 proximate static plate 148 out of which water may drain and debris may be removed.

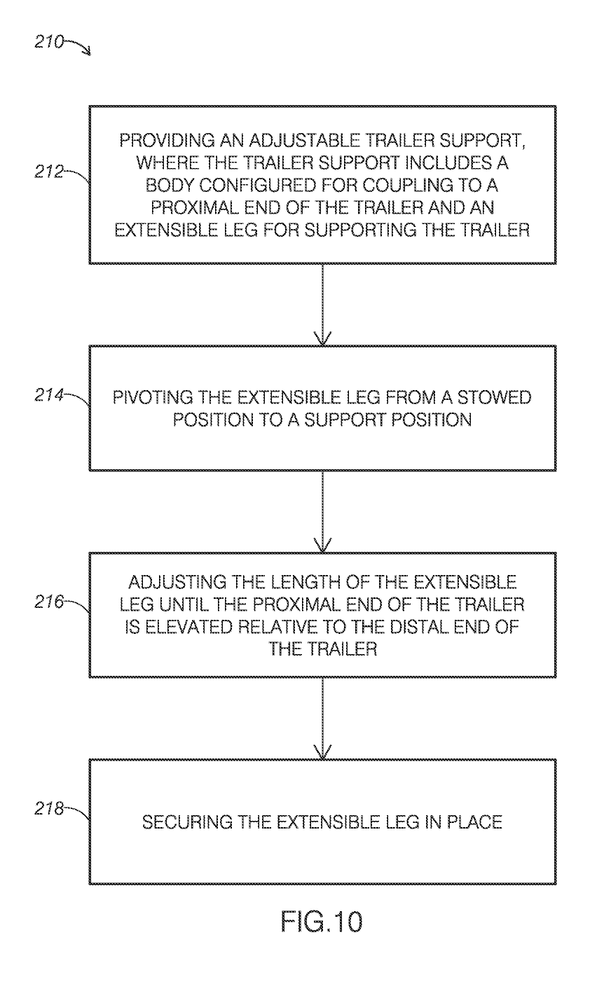

Turning attention to FIG. 10, a method 210 of using a trailer support similar or identical to the trailer supports described above for draining water from a boat supported on a trailer is shown. Method 210 enables a user to drain water from a boat supported on a trailer. Typically, the trailer will have a distal end including wheels and a proximal end including a trailer tongue.

Method 210 includes providing an adjustable trailer support at step 212, where the trailer support includes a body configured for coupling to the proximal end of the trailer and an extensible leg for supporting the trailer. Method 210 further includes pivoting the extensible leg from a stowed position to a support position at step 214. Additionally, method 210 includes adjusting the length of the extensible leg at step 216 until the proximal end of the trailer is elevated relative to the distal end of the trailer. At step 218, method 210 includes securing the extensible leg in place.

Attaching the adjustable trailer support to the trailer at step 212 may be accomplished by coupling the body to the proximal end of the trailer. A user may couple the body to the trailer by first mating a top surface of the body with a bottom portion of a trailer frame beam near the proximal end of the trailer. Second, a user may pass one or more U-bolts through coupling holes that are located on the top surface of the body thereby sandwiching the trailer frame beam between the one or more U-bolts and the top surface of the body.

Next, a user may secure the U-bolts in place by tightening one or more nuts to the U-bolts. Once the nuts are tightened, the nuts will contact a bottom surface of the body. The coupling holes may have any desired spatial arrangement to accommodate different configurations of trailers, coupling plates, mounting means, and so on. Additionally, other methods of fixing the adjustable trailer support to the trailer are envisioned beyond using one or more U-bolts in combination with nuts. For example, a coupling plate may be used combination with one or more bolts and nuts. The coupling plate contacts the top surface of the trailer frame beam and similarly sandwiches the trailer frame between the body and the coupling plate, which is secured using the one or more bolts and nuts.

Pivoting the extensible leg from a stowed position to a support position at step 214 may be accomplished by releasing the extensible leg from the stowed position. A user may release the extensible leg from the stowed position by removing any fixation element used to hold the extensible leg in the stowed position. Once released from the stowed position, a user may pivot the extensible leg along an arc until the extensible leg is to a deployed position, which is relatively vertical. Once the extensible leg; reaches the deployed position a user may pivot the extensible leg along the arc until a deployed lock hole on the body aligns with an extensible leg lock hole on the extensible leg, and then a user may pass a bolt, pin, or other fixation element through the aligned holes to fix their relative position. The extensible leg and the body are pivotably attached and define the adjustable trailer support.

Adjusting the length of the extensible leg at step 216 may be accomplished by first sliding an extension element along a pivot element until an extension element contacts a surface capable of supporting the combined loading the adjustable trailer support, trailer, and trailer load. Once the extensible leg contacts such a surface a user may further slide the extension element along the pivot element thereby adjusting the length of the extensible leg until the proximal end of the trailer is elevated relative to the distal end of the trailer. The extension element and the pivot element are slidably attached and define the extensible leg.

Securing the extensible leg at step 218 may be accomplished by further sliding the extension element along the pivot element until an extension element lock hole aligns with a pivot element lock hole, and then passing a bolt, pin, or other fixation element through the aligned holes to fix their relative position.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An adjustable trailer support for propping up a trailer having a rear end supported by wheels and a front end including a tongue, the adjustable trailer support comprising:
a body element configured to couple to the front end of the trailer; and
a leg for supporting the trailer, the leg including:
a pivot element having a proximal end and a distal end, the proximal end of the pivot element being pivotably coupled to the body element, and
an extension element, the extension element being slidably coupled to the distal end of the pivot element;
wherein the leg is configured to pilot between a stowed position where the leg is longitudinally aligned with the trailer and a support position where the leg is substantially upright.

2. The adjustable trailer support of claim wherein the body element defines a step to accommodate portions of the trailer to which the body element is coupled.

3. The adjustable trailer support of claim 1, wherein:
the extension element includes a proximal end and a distal end opposite the proximal end and defines a plurality of extension element lock holes;
the pivot element defines a plurality of pivot element lock holes between the proximal end of the pivot element and the distal end of the pivot element; and
at least one of the plurality of pivot element lock holes may be selectively aligned with at least one of the plurality of extension element lock holes for locking the extension element.

4. The adjustable trailer support of claim 1, wherein:
the body element defines a plurality of body lock holes;
the pivot element defining a plurality of pivot element lock holes between the proximal end of the pivot element and the distal end of the pivot element opposite the proximal end; and
at least one of the plurality of pivot element lock holes may be selectively aligned with at least one of the plurality of body lock holes for locking the pivot element.

5. The adjustable trailer support of claim 1, wherein the extension element is configured to extend to a length sufficient to elevate the front end of the trailer relative to the rear end of the trailer.

6. The adjustable trailer support of claim 5, wherein the extension element is configured to extend to multiple lengths to change the elevation of the front end of the trailer relative to the rear end of the trailer.

7. The adjustable trailer support of claim 1, further comp biasing mechanism, the biasing mechanism being mounted between the extension element and the pivot element and biasing the extension element away from the pivot element.

8. The adjustable trailer support of claim 1, wherein the extension element resides partially within the pivot element.

9. The adjustable trailer support of claim 5, wherein:
the extension element includes a foot at the distal end of the extension element; and
the foot is a primary contact point on a surface upon which the adjustable trailer support contacts.

10. The adjustable trailer support of claim 9, wherein the foot is a static plate.

11. The adjustable trailer support of claim 9, wherein the foot is a selectively, rotatable wheel.

12. The adjustable trailer support of claim 9, wherein the foot is interchangeable between a static plate and a rotatable wheel.

13. The adjustable trailer support of claim wherein the extension element defines a gap proximate the foot, the gap defining an outlet for draining water from inside the extension element.

14. A method for draining water from a boat supported on a trailer having a distal end including wheels and a proximal end including a trailer tongue, the method comprising the steps of:
providing a body configured for coupling to the proximal end of the trailer;
providing a leg for supporting the trailer, the leg including:
a pivot element having a proximal end and a distal end, the proximal end of the pivot element being pivotably coupled to the body, and
an extension element mounted at least partially within the pivot element and configured to slide beyond the distal end of the pivot element to define an extended length,
the leg being configured to pivot between a stowed position where the leg is longitudinally aligned with the trailer and a support position where the leg is substantially upright;
pivoting the adjustable trailer support from a stowed position to a support position;
adjusting the extended length of the extension element until the proximal end of the trailer is elevated relative to the distal end of the trailer; and
securing the pivot element and extension element place.

15. The method of claim 14, wherein the extension element includes a proximal end and a distal end opposite the proximal end, and defining a plurality of extension element lock holes;
the pivot element defining a plurality of pivot element lock holes between the proximal end and the distal end opposite the proximal end;
aligning a selected extension element lock hole with a selected pivot element lock hole to lock the extension element in a fixed position.

16. A trailer support for supporting a trailer having a tongue section located at a front end of a trailer and a rear end having wheels, the trailer support comprising:
a coupling plate configured to couple to the tongue section of the trailer;
a pivot plate attached to the coupling plate, the pivot plate including a pivot hole and defining a plurality of pivot plate lock holes;
a pivot element including a proximal end and a distal end opposite the proximal end and defining a plurality of pivot element lock holes; and
the proximal end of the pivot element being pivotally fixed at the pivot hole and moveable along an arc from a stowed position extending substantially parallel to the tongue section to a substantially upright support position;
wherein at least one of the plurality of pivot element lock holes may be selectively aligned with at least one of the plurality of pivot plate lock holes for locking the pivot element.

17. The trailer support of claim 16, wherein the pivot plate defines an integrated step to accommodate components of the tongue section of the trailer.

18. The trailer support of claim 16, further comprising an extension element including a proximal end and a distal end opposite the proximal end, and defining a plurality of extension element lock holes; and
the proximal end of the extension element being slidably coupled to the distal end of the pivot element;
wherein at least one of the plurality of pivot element lock holes may be selectively aligned with at least one of the plurality of extension element lock holes for locking the extension element.

19. The trailer support of claim 18, wherein the extension element extends to change the elevation of the tongue section of the trailer relative to the rear end of the trailer.

20. The trailer support of claim 18, wherein the extension element resides partially within the pivot element.
